(19) United States
(12) Patent Application Publication
(10) Pub. No.: US 2015/0199017 A1
(43) Pub. Date: Jul. 16, 2015

(54) COORDINATED SPEECH AND GESTURE INPUT

(71) Applicant: Microsoft Corporation, Redmond, WA (US)

(72) Inventors: Oscar Murillo, Redmond, WA (US); Lisa Stifelman, Palo Alto, CA (US); Margaret Song, Mercer Island, WA (US); David Bastien, Kirkland, WA (US); Mark Schwesinger, Bellevue, WA (US)

(73) Assignee: Microsoft Corporation, Redmond, WA (US)

(21) Appl. No.: 14/152,815

(22) Filed: Jan. 10, 2014

(51) Int. Cl. G06F 3/01

(52) U.S. Cl. CPC G06F 3/017; G06F 3/011

(57) ABSTRACT

A method to be enacted in a computer system operatively coupled to a vision system and to a listening system. The method applies natural user input to control the computer system. It includes the acts of detecting verbal and non-verbal touchless input from a user of the computer system, selecting one of a plurality of user-interface objects based on coordinates derived from the non-verbal, touchless input, decoding the verbal input to identify a selected action from among a plurality of actions supported by the selected object, and executing the selected action on the selected object.

### BACKGROUND

Natural user-input (NUI) technologies aim to provide intuitive modes of interaction between computer systems and human beings. Such modes may include posture, gesture, gaze, and/or speech recognition, as examples. Increasingly, a suitably configured vision and/or listening system may replace or augment traditional user-interface hardware, such as a keyboard, mouse, touch-screen, gamepad, or joystick controller.

Some NUI approaches use gesture input to emulate pointing operations commonly enacted with a mouse, trackball or trackpad. Other approaches use speech recognition for access to a command menu—e.g., commands to launch applications, play audio tracks, etc. It is rare, however, for gesture and speech recognition to be used in the same system.

### SUMMARY

One embodiment provides a method to be enacted in a computer system operatively coupled to a vision system and to a listening system. The method applies natural user input to control the computer system. It includes the acts of detecting verbal and non-verbal touchless input from a user, and selecting one of a plurality of user-interface objects based on coordinates derived from the non-verbal touchless input. The method also includes the acts of decoding the verbal input to identify a selected action supported by the selected object and executing the selected action on the selected object.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an example environment in which NUI is used to control a computer system, in accordance with an embodiment of this disclosure.

FIG. 2 shows aspects of a computer system, NUI system, vision system, and listening system, in accordance with an embodiment of this disclosure.

FIG. 3 shows aspects of an example mapping between a hand position and/or gaze direction of a user and mouse-pointer coordinates on a display screen in sight of the user, in accordance with an embodiment of this disclosure.

FIG. 4 illustrates an example method to apply NUI to control a computer system, in accordance with an embodiment of this disclosure.

FIG. 5 shows aspects of an example virtual skeleton of a computer-system user in accordance with an embodiment of this disclosure.

FIG. 6 illustrates an example method to decode vocalization from a computer-system user, in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

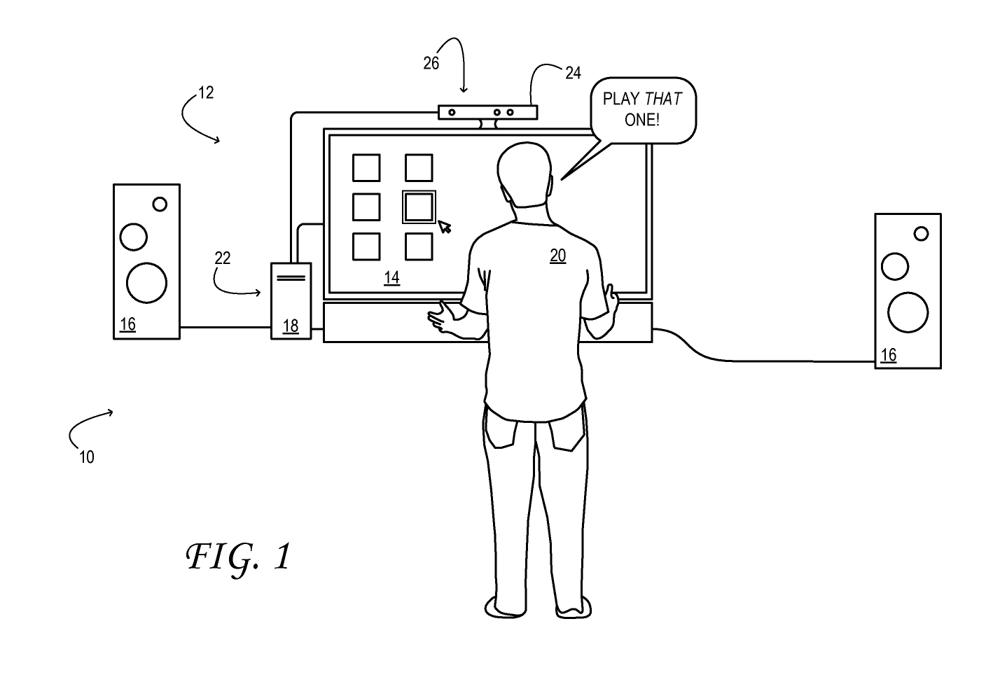

FIG. 1 shows aspects of an example environment 10. The illustrated environment is a living room or family room of a personal residence. However, the approaches described herein are equally applicable in other environments, such as retail stores and kiosks, restaurants, information and public-service kiosks, etc.

The environment of FIG. 1 features a home-entertainment system 12. The home-entertainment system includes a large-format display 14 and loudspeakers 16, both operatively coupled to computer system 18. In other embodiments, such as near-eye display variants, the display may be installed in headwear or eyewear worn by a user of the computer system.

In some embodiments, computer system 18 may be a video-game system. In some embodiments, computer system 18 may be a multimedia system configured to play music and/or video. In some embodiments, computer system 18 may be a general-purpose computer system used for internet browsing and productivity applications—word processing and spreadsheet applications, for example. In general, computer system 18 may be configured for any or all of the above purposes, among others, without departing from the scope of this disclosure.

Computer system 18 is configured to accept various forms of user input from one or more users 20. As such, traditional user-input devices such as a keyboard, mouse, touch-screen, gamepad, or joystick controller (not shown in the drawings) may be operatively coupled to the computer system. Regardless of whether traditional user-input modalities are supported, computer system 18 is also configured to accept so-called natural user input (NUI) from at least one user. In the scenario represented in FIG. 1, user 20 is shown in a standing position; in other scenarios, a user may be seated or lying down, again without departing from the scope of this disclosure.

To mediate NUI from the one or more users, NUI system 22 is part of computer system 18. The NUI system is configured to capture various aspects of the NUI and provide corresponding actionable input to the computer system. To this end, the NUI system receives low-level input from peripheral sensory components, which include vision system 24 and listening system 26. In the illustrated embodiment, the vision system and listening system share a common enclosure; in other embodiments, they may be separate components. In still other embodiments, the vision, listening and NUI systems may be integrated within the computer system. The computer system and the vision system may be coupled via a wired communications link, as shown in the drawing, or in any other suitable manner. Although FIG. 1 shows the sensory components arranged atop display 14, various other arrangements are contemplated as well. The vision system could be mounted on a ceiling, for example.

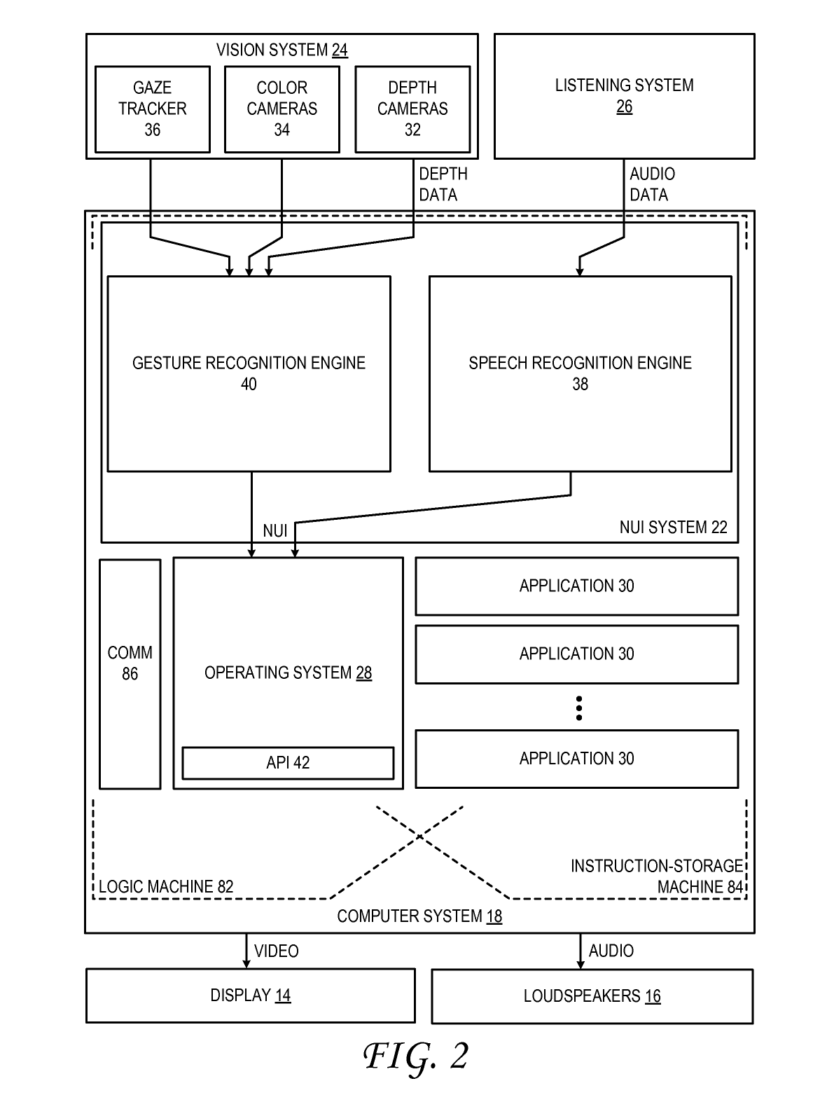

FIG. 2 is a high-level schematic diagram showing aspects of computer system 18, NUI system 22, vision system 24, and listening system 26, in one example embodiment. The illustrated computer system includes operating system (OS) 28, which may be instantiated in software and/or firmware. The computer system also includes one or more applications 30, such as a video-game application, a digital-media player, an internet browser, a photo editor, a word processor, and/or a spreadsheet application, for example. Naturally, the computer, NUI, vision, and/or listening systems may also include suitable data-storage, instruction-storage, and logic hardware, as needed to support their respective functions.

Listening system 26 may include one or more microphones to pick up vocalization and other audible input from one or more users and other sources in environment 10; vision system 24 detects visual input from the users. In the illustrated embodiment, the vision system includes one or more depth cameras 32, one or more color cameras 34, and a gaze tracker 36. In other embodiments, the vision system may include more or fewer components. NUI system 22 processes low-level input (i.e., signal) from these sensory components to provide actionable, high-level input to computer system 18. For example, the NUI system may perform sound- or voice-recognition on an audio signal from listening system 26. Such recognition may generate corresponding text-based or other high-level commands, which are received in the computer system.

Continuing in FIG. 2, each depth camera 32 may include an imaging system configured to acquire a time-resolved sequence of depth maps of one or more human subjects that it sights. As used herein, the term ‘depth map’ refers to an array of pixels registered to corresponding regions (Xᵢ, Yᵢ) of an imaged scene, with a depth value Zᵢ indicating, for each pixel, the depth of the corresponding region. ‘Depth’ is defined as a coordinate parallel to the optical axis of the depth camera, which increases with increasing distance from the depth camera. Operationally, a depth camera may be configured to acquire two-dimensional image data from which a depth map is obtained via downstream processing.

In general, the nature of depth cameras 32 may differ in the various embodiments of this disclosure. For example, a depth camera can be stationary, moving, or movable. Any non-stationary depth camera may have the ability to image an environment from a range of perspectives. In one embodiment, brightness or color data from two, stereoscopically oriented imaging arrays in a depth camera may be co-registered and used to construct a depth map. In other embodiments, a depth camera may be configured to project onto the subject a structured infrared (IR) illumination pattern comprising numerous discrete features—e.g., lines or dots. An imaging array in the depth camera may be configured to image the structured illumination reflected back from the subject. Based on the spacings between adjacent features in the various regions of the imaged subject, a depth map of the subject may be constructed. In still other embodiments, the depth camera may project a pulsed infrared illumination towards the subject. A pair of imaging arrays in the depth camera may be configured to detect the pulsed illumination reflected back from the subject. Both arrays may include an electronic shutter synchronized to the pulsed illumination, but the integration times for the arrays may differ, such that a pixel-resolved time-of-flight of the pulsed illumination, from the illumination source to the subject and then to the arrays, is discernible based on the relative amounts of light received in corresponding elements of the two arrays. Depth cameras 32, as described above, are naturally applicable to observing people. This is due in part to their ability to resolve a contour of a human subject even if that subject is moving, and even if the motion of the subject (or any part of the subject) is parallel to the optical axis of the camera. This ability is supported, amplified, and extended through the dedicated logic architecture of NUI system 22.

When included, each color camera 34 may image visible light from the observed scene in a plurality of channels—e.g., red, green, blue, etc.—mapping the imaged light to an array of pixels. Alternatively, a monochromatic camera may be included, which images the light in grayscale. Color or brightness values for all of the pixels exposed in the camera constitute collectively a digital color image. In one embodiment, the depth and color cameras used in environment 10 may have the same resolutions. Even when the resolutions differ, the pixels of the color camera may be registered to those of the depth camera. In this way, both color and depth information may be assessed for each portion of an observed scene.

It will be noted that the sensory data acquired through NUI system 22 may take the form of any suitable data structure, including one or more matrices that include X, Y, Z coordinates for every pixel imaged by the depth camera, and red, green, and blue channel values for every pixel imaged by color camera, in addition to time resolved digital audio data from listening system 26.

As shown in FIG. 2, NUI system 22 includes a speech-recognition engine 38 and a gesture-recognition engine 40. The speech-recognition engine is configured to process the audio data from listening system 26, to recognize certain words or phrases in the user's speech, and to generate corresponding actionable input to OS 28 or applications 30 of computer system 18. The gesture-recognition engine is configured to process at least the depth data from vision system 24, to identify one or more human subjects in the depth data, to compute various skeletal features of the subjects identified, and to gather from the skeletal features the various postural or gestural information used as NUI to the OS or applications. These functions of the gesture-recognition engine are described hereinafter, in greater detail.

Continuing in FIG. 2, an application-programming interface (API) 42 is included in OS 28 of computer system 18. This API offers callable code to provide actionable input for a plurality of processes running on the computer system based on a subject's input gesture and/or speech. Such processes may include application processes, OS processes, and service processes, for example. In one embodiment, the API may be distributed in a software-development kit (SDK) provided to application developers by the OS maker.

In the various embodiments contemplated herein, some or all of the recognized input gestures may include gestures of the hands. In some embodiments, the hand gestures may be performed in concert or in series with an associated body gesture.

In some embodiments and scenarios, a UI element presented on display 14 is selected by the user in advance of activation. In more particular embodiments and scenarios, such selection may be received from the user through NUI. To this end, gesture-recognition engine 40 may be configured to relate (i.e., map) a metric from user's posture to screen coordinates on display 14. For example, the position of the user's right hand may be used to compute ‘mouse-pointer’ coordinates. Feedback to the user may be provided by presentation of a mouse-pointer graphic on the display screen at the computed coordinates. In some examples and usage scenarios, selection focus among the various UI elements presented on the display screen may be awarded based on proximity to the computed mouse-pointer coordinates. It will be noted that use of the terms ‘mouse-pointer’ and ‘mouse-pointer coordinates’ does not require the use of a physical mouse, and the pointer graphic may have virtually any visual appearance—e.g., a graphical hand.

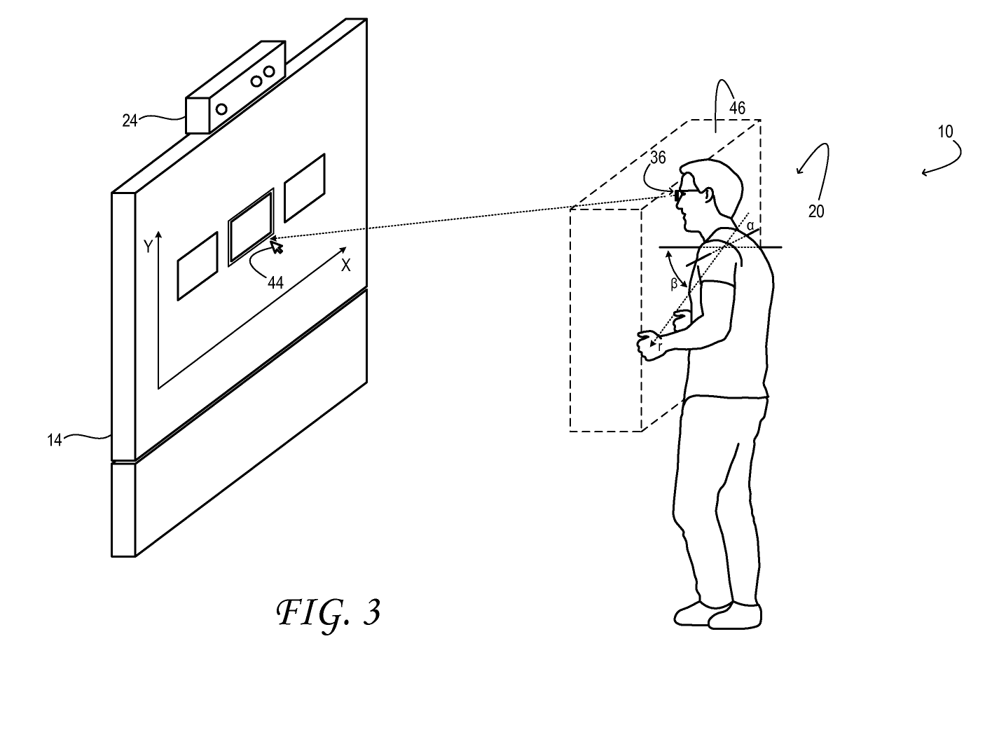

One example of the mapping noted above is represented visually in FIG. 3, which also shows an example mouse pointer 44. Here, the user's right hand moves within an interaction zone 46. The position of the centroid of the right hand may be tracked via gesture-recognition engine 40 in any suitable coordinate system—e.g., relative to a coordinate system fixed to the user's torso, as shown in the drawing. This approach offers an advantage in that the mapping can be made independent of the user's orientation relative to vision system 24 or display 14. Thus, in the illustrated example, the gesture-recognition engine is configured to map coordinates of the user's right hand in the interaction zone—(r, α, β) in FIG. 10—to coordinates (X, Y) in the plane of the display. In one embodiment, the mapping may involve projection of the hand coordinates (X′, Y′, Z′), in the frame of reference of the interaction zone, onto a vertical plane parallel to the user's shoulder-to-shoulder axis. The projection is then scaled appropriately to arrive at the display coordinates (X, Y). In other embodiments, the projection may take into account the natural curvature of the user's hand trajectory as the hand is swept horizontally or vertically in front of the user's body. In other words, the projection may be onto a curved surface rather than a plane, and then flattened to arrive at the display coordinates. In either case, the UI element whose coordinates most closely match the computed mouse-pointer coordinates may be awarded selection focus. This UI element then may be activated in various ways, as further described below.

In this and other embodiments, NUI system 22 may be configured to provide alternative mappings between a user's hand gestures and the computed mouse-pointer coordinates. For instance, the NUI system may simply estimate the locus on display 14 that the user is pointing to. Such an estimate may be made based on hand position and/or position of the fingers. In still other embodiments, the user's focal point or gaze direction may be used as a parameter from which to compute the mouse-pointer coordinates. In FIG. 3, accordingly, a gaze tracker 36 is shown being worn over the user's eyes. The user's gaze direction may be determined and used in lieu of hand position to compute the mouse-pointer coordinates that enable UI-object selection.

The configurations described above enable various methods to apply NUI to control a computer system. Some such methods are now described, by way of example, with continued reference to the above configurations. It will be understood, however, that the methods here described, and others within the scope of this disclosure, may be enabled by different configurations as well. The methods herein, which involve the observation of people in their daily lives, may and should be enacted with utmost respect for personal privacy. Accordingly, the methods presented herein are fully compatible with opt-in participation of the persons being observed. In embodiments where personal data is collected on a local system and transmitted to a remote system for processing, that data can be anonymized. In other embodiments, personal data may be confined to a local system, and only non-personal, summary data transmitted to a remote system.

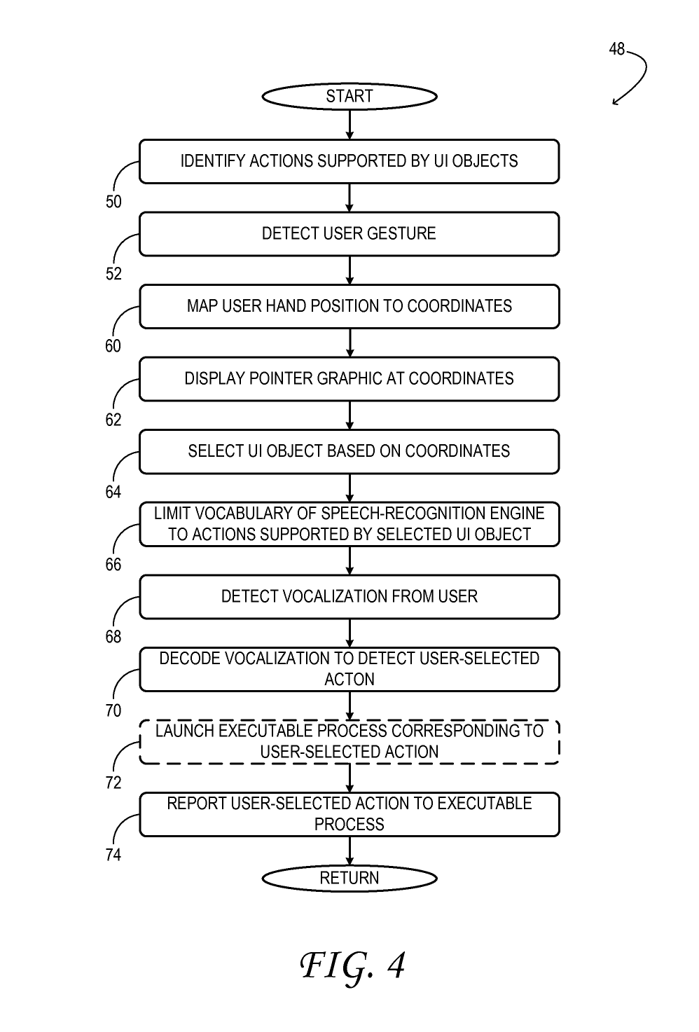

FIG. 4 illustrates an example method 48 to be enacted in a computer system operatively coupled to a vision system, such as vision system 24, and to a listening system such as listening system 26. The illustrated method is a way to apply natural user input (NUI) to control the computer system.

At 50 of method 48, an accounting is taken of each selectable UI element currently presented on a display of the computer system, such as display 14 of FIG. 1. In one embodiment, such accounting is done in the OS of the computer system. For each selectable UI element detected, the OS identifies which user actions are supported by the software object associated with that element. If the UI element is a tile representing an audio track, for example, the supported actions may include PLAY, VIEW_ALBUM_ART, BACKUP, and RECYCLE. If the UI element is a tile representing a text document, the supported actions may include PRINT, EDIT and READ_ALOUD. If the UI element is a checkbox or radio button associated with an active process on the computer system, the supported actions may include SELECT and DESELECT. Naturally, the above examples are not intended to be exhaustive. In some embodiments, identifying the plurality of actions supported by the selected UI object may include searching a system registry for an entry corresponding to the software object associated with that element. In other embodiments, the supported actions may be determined via direct interaction with the software object—e.g., launching a process associated with the object and querying the process for a list of supported actions. In still other embodiments, the supported actions may be identified heuristically, based on which type of UI element appears to be presented.

At 52 a gesture of the user is detected. In some embodiments, this gesture may be defined at least partly in terms of a position of a hand of the user with respect to the user's body. Gesture detection is a complex process that admits of numerous variants. For ease of explanation, one example variant is described here.

Gesture detection may begin when depth data is received in NUI system 22 from vision system 26. In some embodiments, such data may take the form of a raw data stream—e.g., a video or depth-video stream. In other embodiments, the data already may have been processed to some degree within the vision system. Through subsequent actions, the data received in the NUI system is further processed to detect various states or conditions that constitute user input to computer system 18, as further described below.

Continuing, at least a portion of one or more human subjects may be identified in the depth data by NUI system 22. Through appropriate depth-image processing, a given locus of a depth map may be recognized as belonging to a human subject. In a more particular embodiment, pixels that belong to a human subject are identified by sectioning off a portion of the depth data that exhibits above-threshold motion over a suitable time scale, and attempting to fit that section to a generalized geometric model of a human being. If a suitable fit can be achieved, then the pixels in that section are recognized as those of a human subject. In other embodiments, human subjects may be identified by contour alone, irrespective of motion.

In one, non-limiting example, each pixel of a depth map may be assigned a person index that identifies the pixel as belonging to a particular human subject or non-human element. As an example, pixels corresponding to a first human subject can be assigned a person index equal to one, pixels corresponding to a second human subject can be assigned a person index equal to two, and pixels that do not correspond to a human subject can be assigned a person index equal to zero. Person indices may be determined, assigned, and saved in any suitable manner.

After all the candidate human subjects are identified in the fields of view (FOVs) of each of the connected depth cameras, NUI system 22 may make the determination as to which human subject (or subjects) will provide user input to computer system 18—i.e., which will be identified as a user. In one embodiment, a human subject may be selected as a user based on proximity to display 14 or depth camera 32, and/or position in a field of view of a depth camera. More specifically, the user selected may be the human subject closest to the depth camera or nearest the center of the FOV of the depth camera. In some embodiments, the NUI system may also take into account the degree of translational motion of a human subject—e.g., motion of the centroid of the subject—in determining whether that subject will be selected as a user. For example, a subject that is moving across the FOV of the depth camera (moving at all, moving above a threshold speed, etc.) may be excluded from providing user input.

After one or more users are identified, NUI system 22 may begin to process posture information from such users. The posture information may be derived computationally from depth video acquired with depth camera 32. At this stage of execution, additional sensory input—e.g., image data from a color camera 34 or audio data from listening system 26—may be processed along with the posture information. Presently, an example mode of obtaining the posture information for a user will be described.

In one embodiment, NUI system 22 may be configured to analyze the pixels of a depth map that correspond to a user, in order to determine what part of the user's body each pixel represents. A variety of different body-part assignment techniques can be used to this end. In one example, each pixel of the depth map with an appropriate person index (vide supra) may be assigned a body-part index. The body-part index may include a discrete identifier, confidence value, and/or body-part probability distribution indicating the body part or parts to which that pixel is likely to correspond. Body-part indices may be determined, assigned, and saved in any suitable manner.

In one example, machine-learning may be used to assign each pixel a body-part index and/or body-part probability distribution. The machine-learning approach analyzes a user with reference to information learned from a previously trained collection of known poses. During a supervised training phase, for example, a variety of human subjects may be observed in a variety of poses; trainers provide ground truth annotations labeling various machine-learning classifiers in the observed data. The observed data and annotations are then used to generate one or more machine-learned algorithms that map inputs (e.g., observation data from a depth camera) to desired outputs (e.g., body-part indices for relevant pixels).

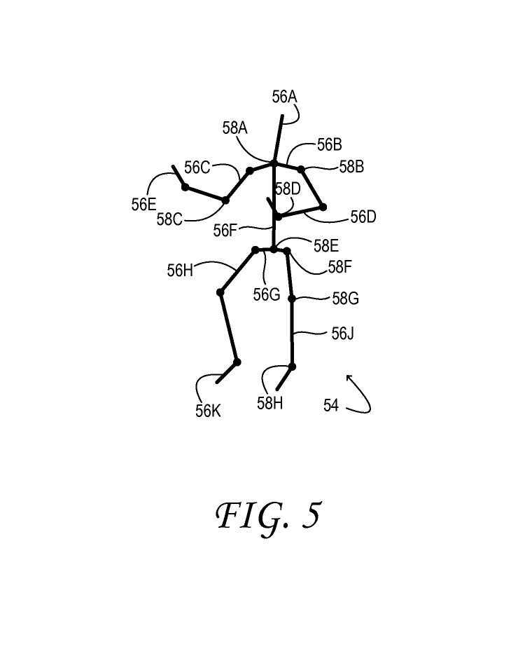

Thereafter, a virtual skeleton is fit to at least one human subject identified. In some embodiments, a virtual skeleton is fit to the pixels of depth data that correspond to a user. FIG. 5 shows an example virtual skeleton 54 in one embodiment. The virtual skeleton includes a plurality of skeletal segments 56 pivotally coupled at a plurality of joints 58. In some embodiments, a body-part designation may be assigned to each skeletal segment and/or each joint. In FIG. 5, the body-part designation of each skeletal segment 56 is represented by an appended letter: A for the head, B for the clavicle, C for the upper arm, D for the forearm, E for the hand, F for the torso, G for the pelvis, H for the thigh, J for the lower leg, and K for the foot. Likewise, a body-part designation of each joint 58 is represented by an appended letter: A for the neck, B for the shoulder, C for the elbow, D for the wrist, E for the lower back, F for the hip, G for the knee, and H for the ankle. Naturally, the arrangement of skeletal segments and joints shown in FIG. 5 is in no way limiting. A virtual skeleton consistent with this disclosure may include virtually any type and number of skeletal segments and joints.

In one embodiment, each joint may be assigned various parameters—e.g., Cartesian coordinates specifying joint position, angles specifying joint rotation, and additional parameters specifying a conformation of the corresponding body part (hand open, hand closed, etc.). The virtual skeleton may take the form of a data structure including any, some, or all of these parameters for each joint. In this manner, the metrical data defining the virtual skeleton—its size, shape, and position and orientation relative to the depth camera may be assigned to the joints.

Via any suitable minimization approach, the lengths of the skeletal segments and the positions and rotational angles of the joints may be adjusted for agreement with the various contours of the depth map. This process may define the location and posture of the imaged human subject. Some skeletal-fitting algorithms may use the depth data in combination with other information, such as color-image data and/or kinetic data indicating how one locus of pixels moves with respect to another.

As noted above, body-part indices may be assigned in advance of the minimization. The body-part indices may be used to seed, inform, or bias the fitting procedure to increase its rate of convergence. For example, if a given locus of pixels is designated as the head of the user, then the fitting procedure may seek to fit to that locus a skeletal segment pivotally coupled to a single joint—viz., the neck. If the locus is designated as a forearm, then the fitting procedure may seek to fit a skeletal segment coupled to two joints—one at each end of the segment. Furthermore, if it is determined that a given locus is unlikely to correspond to any body part of the user, then that locus may be masked or otherwise eliminated from subsequent skeletal fitting. In some embodiments, a virtual skeleton may be fit to each of a sequence of frames of depth video. By analyzing positional change in the various skeletal joints and/or segments, the corresponding movements—e.g., gestures, actions, or behavior patterns—of the imaged user may be determined. In this manner, the posture or gesture of the one or more human subjects may be detected in NUI system 22 based on one or more virtual skeletons.

The foregoing description should not be construed to limit the range of approaches usable to construct a virtual skeleton, for a virtual skeleton may be derived from a depth map in any suitable manner without departing from the scope of this disclosure. Moreover, despite the advantages of using a virtual skeleton to model a human subject, this aspect is by no means necessary. In lieu of a virtual skeleton, raw point-cloud data may be used directly to provide suitable posture information.

In subsequent acts of method 48, various higher-level processing may be enacted to extend and apply the gesture detection undertaken at 52. In some examples, gesture detection may proceed until an engagement gesture or spoken engagement phrase from a potential user is detected. After a user has engaged, processing of the data may continue, with gestures of the engaged user decoded to provide input to computer system 18. Such gestures may include input to launch a process, change a setting of the OS, shift input focus from one process to another, or provide virtually any control function in computer system 18.

Returning now to the specific embodiment of FIG. 4, the position of the hand of the user, at 60, is mapped to corresponding mouse-pointer coordinates. In one embodiment, such mapping may be enacted as described in the context of FIG. 3. However, it will be noted that hand position is only one example of non-verbal touchless input from a computer-system user that may be detected and mapped to UI coordinates for the purpose of selecting a UI object on the display system. Other equally suitable forms of non-verbal touchless user input include a pointing direction of the user, a head or body orientation of the user, a body pose or posture of the user, and a gaze direction or focal point of the user, for example.

At 62, a mouse-pointer graphic is presented on the computer-system display at the mapped coordinates. Presentation of the mouse-pointer graphic provides visual feedback to indicate the currently targeted UI element. At 64 a UI object is selected based on proximity to the mouse-pointer coordinates. As noted above, the selected UI element may be one of a plurality of UI elements presented on the display, which is arranged in sight of the user. The UI element may be a tile, icon, or UI control (checkbox or radio button), for example.

The selected UI element may be associated with a plurality of user actions, which are the actions (methods, functions, etc.) supported by the software object owning the UI element. In method 48, any of the supported actions may be selected by the user via speech-recognition engine 38. Whatever approach is to be used to select one of these actions, it is generally not productive to allow the request of an action that is not supported by the UI object selected. In a typical scenario, the selected UI object will only support a subset of the actions globally recognizable by speech-recognition engine 38. Accordingly, at 66 of method 48, a vocabulary of speech-recognition engine 38 is actively limited (i.e., truncated) to conform to the subset of actions supported by the selected UI object. Then, at 68, vocalization from the user is detected in speech-recognition engine 38. At 70 the vocalization is decoded to identify the selected action from among the plurality of actions supported by the selected UI object. Such actions may include PLAY, EDIT, PRINT, SHARE_WITH_FRIENDS, among others.

The foregoing process flow provides that mouse-pointer coordinates are computed based on non-verbal, touchless input from a user, that a UI-object is selected based on the mouse-pointer coordinates, and that the vocabulary of the speech-recognition engine is constrained based on the UI object selected. In a larger sense, the approach of FIG. 4 provides that, over a first range of the mouse-pointer coordinates, a speech-recognition engine is operated to recognize vocalization within a first vocabulary, and over a second range to recognize the vocalization within a second, inequivalent vocabulary. Here, the first vocabulary may include only those actions supported by a UI object displayed within the first range of mouse-pointer coordinates—e.g., a two-dimensional X, Y range. Moreover, the very act of computing mouse-pointer coordinates within the first range may activate a UI object located there—viz., in the manner specified by the user's vocalization.

It is not necessarily the case, however, that every range of mouse-pointer coordinates must have a UI object associated with it. On the contrary, computing coordinates in a second range may direct subsequent verbal input to an OS of the computer system, with such verbal input decoded using a combined, OS-level vocabulary.

It will be noted that in method 48, at least, selection of the UI object does not specify the action to be performed on that object, and determining the selected action does not specify the receiver of that action—i.e., the vocalization detected at 68 and decoded at 70 is not used to select the UI object. Such selection is instead completed prior to detection of the vocalization. In other embodiments, however, the vocalization may be used to select a UI object or to influence the process by which the UI object is selected, as further described below.

The UI object selected at 64 of method 48 may represent or be otherwise associated with an executable process in computer system 18. In such cases, the associated executable process may be an active process or an inactive process. In scenarios in which the executable process is inactive—i.e., not already running—execution of the method may advance to 72, where the associated executable process is launched. In scenarios in which the executable process is active, this step may be omitted. At 74 of method 48, the selected action is reported to the executable process, which is now active. The selected action may be reported in any suitable manner. In embodiments in which the executable process accepts a parameter list on launching, that action may be included in the parameter list—e.g., ‘wrdprcssr.exe mydoc.doc PRINT’. In other embodiments, the executable process may be configured to respond to system input after it has already launched. Either way, the selected action is applied to the selected UI object, via the executable process.

In the embodiment illustrated in FIG. 4, a UI object is selected based on non-verbal, touchless user input in the form of a hand gesture, and the selected action is determined based on verbal user input. Further, the non-verbal, touchless user input is used to constrain the return-parameter space of the verbal user input by limiting the vocabulary of speech-recognition engine 38. However, the converse of this approach is also possible, and is fully contemplated in this disclosure. In other words, the verbal user input may be used to constrain the return-parameter space of the non-verbal, touchless user input. One example of the latter approach occurs when the non-verbal, touchless user input is consistent with selection of a plurality of nearby UI objects, which differ with respect to their supported actions. For instance, one tile representing a movie may be arranged on the display screen, adjacent to another tile that represents a text document. Using a hand gesture or gaze direction, the user may position the mouse pointer between or equally close to the two tiles, and pronounce the word “edit.” In the above method, the OS of the computer system has already established (at 50) that the EDIT action is supported for the text document but not for the movie. The fact that the user desires to edit something may be used, accordingly, to disambiguate an imprecise hand gesture or gaze direction to enable the system to arrive at the desired result. In general terms, the act of detecting the user gesture, at 52, may include the act of selecting, from a plurality of nearby UI objects, one that supports the action indicated by the verbal user input, while dismissing a UI object that does not support the indicated action. Thus, when the NUI includes both verbal and non-verbal touchless input from a user, either form of input may be used to constrain the return-parameter space of the other form. This strategy may be used, effectively, to reduce noise in the other form of input.

In the foregoing examples, a UI object is selected based on the non-verbal touchless input, in whole or in part, while the selected action is determined based on the verbal input. This approach makes good use of non-verbal, touchless input to provide arbitrarily fine spatial selection, which could be inefficient using verbal commands. Verbal commands, meanwhile, are used to provide user access to an extensible library of action words, which, if they had to be presented for selection on the display screen, might clutter the UI. Despite these advantages, it will be noted that in some embodiments, a UI object may be selected based on the verbal user input, and the selected action may be determined based on the non-verbal, touchless user input. The latter approach could be taken, for example, if many elements were available for selection, with relatively few user actions supported by each one.

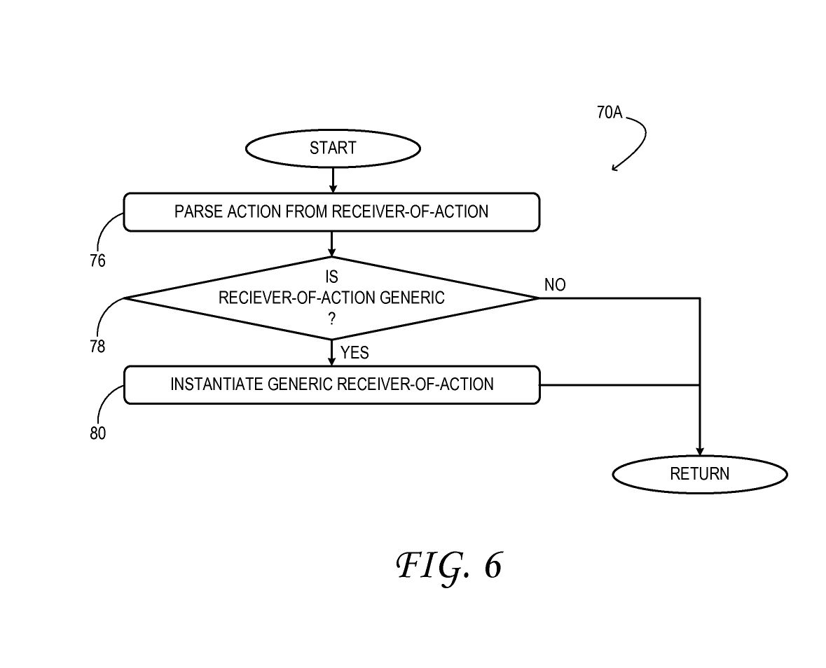

FIG. 6 illustrates aspects of an example method 70A to decode vocalization from a computer-system user. This method may be enacted as part of method 48—e.g., at 70 of FIG. 4—or enacted independent of method 48.

At the outset of method 70A, it may be assumed that a user's vocalization expresses a selected action in terms of an action word, i.e., a verb, plus an object word or phrase, which specifies the receiver of the action. For instance, the user may say “Play Call of Duty,” in which “play” is the action word, and “Call of Duty” is the object phrase. In another example, the user may use non-verbal touchless input to select a photo, and then say “Share with Greta and Tom.” “Share” is the action word in this example, and “Greta and Tom” is the object phrase. Thus, at 76 of method 70A, an action word and a word or phrase specifying the receiver of the action are parsed from the user's vocalization, by speech-recognition engine 38.

At 78 it is determined whether the decoded word or phrase specifying the receiver of the action is generic. Unlike in the above examples, where the object phrase uniquely defines the receiver of the action, the user may have said “Play that one,” or “Play this,” where “that one” and “this” are generic receivers of the action word “play.” If the decoded receiver of the action is generic, then the method advances to 80, where that generic receiver of action is instantiated based on context derived from the non-verbal, touchless input. In one embodiment, the generic receiver of action is replaced in a command string by the software object associated with the currently selected UI element. In other examples, the user may say, “Play the one below,” and “the one below” would be replaced by the object associated with the UI element arranged directly below the currently selected UI element. In some embodiments, a generic receiver term may be instantiated differently for different forms of non-verbal, touchless user input. For instance, NUI system 22 may be configured to map the user's hand position as well as track the user's gaze. In such examples, a hierarchy may be established, where, for example, the UI element being pointed to is selected to replace the generic term if the user is pointing. Otherwise, the UI element nearest the user's focal point may be selected to replace the generic term.

As evident from the foregoing description, the methods and processes described herein may be tied to a computing system of one or more computing machines. Such methods and processes may be implemented as a computer-application program or service, an application-programming interface (API), a library, and/or other computer-program product.

Shown in FIG. 2 in simplified form, computer system 18 is a non-limiting example of a system used to enact the methods and processes described herein. The computer system includes a logic machine 82 and an instruction-storage machine 84. The computer system also includes a display 14, a communication system 86, and various components not shown in FIG. 2.

Logic machine 82 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic machine 82 may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Instruction-storage machine 84 includes one or more physical devices configured to hold instructions executable by logic machine 82 to implement the methods and processes described herein. When such methods and processes are implemented, the state of the instruction-storage machine may be transformed—e.g., to hold different data. The instruction-storage machine may include removable and/or built-in devices; it may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The instruction-storage machine may include volatile, nonvolatile, dynamic, static, read/write, read-only, random-access, sequential-access, location-addressable, file-addressable, and/or content-addressable devices.

It will be appreciated that instruction-storage machine 84 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 82 and instruction-storage machine 84 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms ‘module,’ ‘program,’ and ‘engine’ may be used to describe an aspect of a computing system implemented to perform a particular function. In some cases, a module, program, or engine may be instantiated via logic machine 82 executing instructions held by instruction-storage machine 84. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms ‘module,’ ‘program,’ and ‘engine’ may encompass individual or groups of executable files, data files, libraries, drivers, scripts, database records, etc.

It will be appreciated that a ‘service’, as used herein, is an application program executable across multiple user sessions. A service may be available to one or more system components, programs, and/or other services. In some implementations, a service may run on one or more server-computing devices.

When included, communication system 86 may be configured to communicatively couple NUI system 22 or computer system 18 with one or more other computing devices. The communication system may include wired and/or wireless communication devices compatible with one or more different communication protocols. As non-limiting examples, the communication system may be configured for communication via a wireless telephone network, or a wired or wireless local- or wide-area network. In some embodiments, the communication system may allow a computing system to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. Enacted in a computer system operatively coupled to a vision system, a method to apply natural user input (NUI) to control the computer system, the method comprising:
detecting a gesture of a user of the computer system, the gesture characterized by a position of a hand with respect to a body of the user;
selecting, based on coordinates derived from the position of the hand, one of a plurality of user-interface (UI) objects displayed on a UI in sight of the user, the selected UI object supporting a plurality of actions;
detecting vocalization from the user;
decoding the vocalization to identify a selected action from among the plurality of actions supported by the selected UI object; and
executing the selected action on the selected UI object.

2. The method of claim 1, wherein the selected UI object represents an executable process in the computer system, the method further comprising:
launching the executable process after the vocalization is decoded; and
reporting the selected action to the executable process.

3. The method of claim 1, further comprising, prior to detecting the gesture and vocalization, identifying the plurality of actions supported by the selected UI object.

4. The method of claim 1, further comprising mapping the position of the hand of the user to the coordinates, and displaying a pointer graphic on the UI at the coordinates.

5. Enacted in a computer system operatively coupled to a vision system, a method to apply natural user input (NUI) to control the computer system, the method comprising:
detecting one of non-verbal, touchless input and verbal input as a first type of natural user input;
detecting a second type of natural user input, the second type being verbal input if the first type is non-verbal touchless input, the second type being non-verbal touchless input if the first type is verbal input;
using the first type of user input to constrain a return-parameter space of the second type of user input to reduce noise in the first type of input;
selecting a user-interface (UI) object based on the first type of user input;
determining a selected action for the selected UI object based on the second type of user input; and
executing the selected action on the selected UI object.

6. The method of claim 5, wherein selection of the UI object does not specify the selected action, and wherein determining the selected action does not specify a receiver of the selected action.

7. The method of claim 5, wherein the non-verbal touchless user input provides one or more of a pointing direction of the user, a head or body orientation of the user, a pose or posture of the user, and a gaze direction or focal point of the user.

8. The method of claim 5, wherein the non-verbal, touchless user input is used to constrain the return-parameter space of the verbal user input.

9. The method of claim 8, wherein the non-verbal, touchless user input selects a UI object that supports a subset of actions recognizable by a speech-recognition engine of the computer system, the method further comprising:
limiting a vocabulary of the speech-recognition engine to the subset of actions supported by the UI object.

10. The method of claim 5, wherein the UI object is selected based on the non-verbal, touchless user input and the selected action is determined based on the verbal user input.

11. The method of claim 10, wherein determining the selected action for the selected UI object includes:
decoding a generic term for a receiver of the selected action; and
instantiating the generic receiver term based on context derived from the non-verbal, touchless user input.

12. The method of claim 11, wherein the generic receiver term is instantiated differently for different forms of non-verbal, touchless user input.

13. The method of claim 5, wherein the verbal user input is used to constrain the return-parameter space of the non-verbal, touchless user input.

14. The method of claim 13, wherein the non-verbal, touchless user input is consistent with user selection of a plurality of nearby UI objects that differ with respect to supported actions, the method further comprising:
selecting, from the plurality of nearby UI objects, one that supports the action indicated by the verbal user input, while dismissing a UI object that does not support the indicated action.

15. The method of claim 5, wherein the UI object is selected based on the verbal user input and the selected action is determined based on the non-verbal, touchless user input.

16. Enacted in a computer system operatively coupled to a vision system, a method to apply natural user input (NUI) to control the computer system, the method comprising:
detecting non-verbal, touchless input;
computing, based on the non-verbal, touchless user input, coordinates on a user interface (UI) arranged in sight of the user;
detecting a vocalization;
if the coordinates are within a first range, operating a speech-recognition engine of the computer system to interpret the vocalization using a first set of vocabulary; and
if the coordinates are within a second range, different than the first range, operating the speech-recognition engine to interpret the vocalization using a second set of vocabulary, which differs from the first set.

17. The method of claim 16, wherein the non-verbal, touchless user input includes a position of a hand of the user with respect to the user's body, and wherein computing the target coordinates includes mapping the hand position to the target coordinates.

18. The method of claim 16, wherein the first set of vocabulary includes actions supported by a UI object displayed within the first range.

19. The method of claim 18, wherein computing coordinates in the first range activates the first UI object.

20. The method of claim 18, wherein computing coordinates in the second range invokes an operating system (OS) of the computer system, and wherein the second set of vocabulary is a combined, OS-level vocabulary.
